(19) United States
(12) Patent Application Publication
(10) Pub. No.: US 2016/0099502 A1
(43) Pub. Date: Apr. 7, 2016

(54) DEVICE AND METHOD FOR RECEIVING SIGNALS BY A PLURALITY OF RECEIVING ARRAYS

(71) Applicant: International Business Machines Corporation, ARMONK, NY (US)

(72) Inventors: Giovanni Cherubini, Rueschlikon (CH); Paul Hurley, Oberrieden (CH); Orhan Oecal, Berkeley, CA (US)

(21) Appl. No.: 14/873,353

(22) Filed: Oct. 2, 2015

(30) Foreign Application Priority Data
Oct. 2, 2014 (GB) 1417461.9

(51) Int. Cl. H01Q 3/40; H01Q 21/06

(52) U.S. Cl. CPC H01Q 3/40; H01Q 21/061

(57) ABSTRACT

Device and method for receiving signals by a plurality of receiving arrays. The device includes a plurality L of receiving arrays, each of the L receiving arrays including: a respective number L1, L2, . . . , LL of receiving elements and being adapted to generate time-series output data signals based on received signals; a randomizing unit adapted to generate a randomized matrix for each of the receiving arrays, each of the randomized matrices having a respective a dimensionality M1, M2, . . . , ML, wherein M1<L1, M2<L2, . . . , ML<LL, wherein each of the generated randomized matrices is applied to the corresponding receiving array of the plurality L of receiving arrays to perform beamforming across each of the receiving arrays of plurality L of receiving arrays; and an output unit adapted to output beamformed time-series output data signals.

### CROSS-REFERENCE TO RELATED APPLICATION

This application claims the benefit of priority to United Kingdom Patent Application No. 1417461.9, filed Oct. 2, 2014, the contents of which are incorporated herein by reference.

### BACKGROUND

The present invention relates to a device and to a method for receiving signals by a plurality of receiving arrays, each receiving array including a number of receiving elements. Modern large-scale radio telescope arrays use antenna stations composed of multiple smaller antennas that are placed closely for imaging the sky. Such antenna stations are for example described in M. de Vos at al., “The LOFAR Telescope: System Architecture and Signal Processing”, Proc. IEEE, vol. 97, no. 8, pp. 1431-1437, August 2009 or P. E. Dewdney at al., “The Square Kilometre Array”, Proc. IEEE, vol. 97, no. 8, pp. 1482-1496, August 2009.

The signals received by the antennas at a station are combined by beamforming to reduce the amount of data to be processed in the later stages. The signals sent out from the stations are then correlated to obtain visibilities, which correspond to samples of a Fourier transform of the sky image. The goal then is to reconstruct the sky image from the visibility measurements.

Currently, beamforming at antenna stations is done by conjugate matched beamforming towards the center of the field of view at all antenna stations. Because the beam-shapes created at the stations are essentially the same and any differences are only due to the rotation of the stations with respect to each other, the information received by the antenna stations is merely coded in the phase of the signal because all of the stations scale the signal coming from a particular direction equally.

Accordingly, it is an aspect of the present invention to improve the reconstruction fidelity and the information content of the coded signals.

### SUMMARY

According to one aspect, a device for receiving signals by a plurality of receiving arrays is suggested. The device includes a plurality L of receiving arrays, each of the L receiving arrays including a respective number L1, L2, . . . , LL of receiving elements and being adapted to generate time-series output data signals based on received signals, a randomizing unit being adapted to generate a randomized matrix for each of the receiving arrays of the plurality L of receiving arrays, each of the randomized matrices having a respective dimensionality M1, M2, . . . , ML, wherein M1<L1, M2<L2, . . . , ML<LL, wherein each of the generated randomized matrices is applied to the corresponding receiving array of the plurality L of receiving arrays to perform beamforming across each of the receiving arrays of the plurality L of receiving arrays, and an output unit being adapted to output beamformed time-series output data signals from each of the receiving arrays of the plurality L of receiving arrays.

This aspect is based on the idea to have different beamshapes for each of the receiving arrays, and hence to code information contained in the received signals, both in the phase, i.e., the time delay, and the magnitude of the received signals. Received signals in this context refer to signals being received by the receiving arrays from outside, for example in the form of electromagnetic waves, whose information content represents graphical images from the sky. However, the received signals can also be any kind of radio signal. For instance, the device can be used for remote sensing by interferometry. Generally, the receiving elements can be sensors for sensing signals.

By applying random beamforming across each of the receiving arrays, also called antenna stations, this device provides a method to improve the information content that is received within the received signals. Randomized beamforming is used on the plurality of receiving arrays in a complementary fashion. This means that the randomization of beamforms at the receiving arrays can distinguish the information captured by one of the receiving arrays, i.e. one group of receiving elements from the information retrieved by another group of receiving elements. This can increase the quality of the overall information and can result in an increase in the cumulative information content acquired for instance by an interferometer.

In common systems, receiving elements are grouped to form stations or arrays. Signals received by the receiving elements at the stations are beamformed and sent to a central correlator. However, beamforming is done the same way in all arrays. The uniform beamforming approach aims to maximize the signal-to-noise ratio (SNR).

In contrast to this, the suggested device uses different randomized beamforming at each receiving array. By having the beamforms at the different receiving arrays act independently, the device can improve the quality of the total information content. The randomized matrices can be generated periodically in order to alter the beamforms at the different receiving arrays also periodically. The different beams thus work collaboratively and both SNR and the information content of the received signals is considered.

Each of the plurality L of receiving arrays includes a number of receiving elements. The number of receiving elements can vary from array to array, but can also be equal. Thus, each of the receiving arrays includes a number L1, L2, . . . , LL of receiving elements, wherein L1, L2, . . . , LL can have different amounts but can also be equal or partially equal. For each of the plurality L of receiving arrays, a randomized matrix is generated, wherein the dimensionalities of each matrix is smaller than the number of receiving elements of the corresponding receiving array.

According to one aspect of the present invention, each of the received signals has a dimensionality L1, L2, . . . , LL and each of the beamformed time-series output data signals has a dimensionality M1, M2, . . . , ML.

This corresponds to a transposition of a vector having a higher dimensionality to a vector having a lower dimensionality. This is done at a plurality of time instants.

According to one aspect of the present invention, the randomizing unit is adapted to, when performing beamforming across each of the receiving arrays, combine the time-series output data signals based on received signals from each of the receiving elements of the corresponding receiving array according to the corresponding randomized matrix.

The beamforming is done across the receiving elements, i.e. at the array level, and not per receiving element. Using different dimensionalities, the L1-dimensional vector (or L2-dimensional vector, . . . , LL-dimensional vector, respectively) of one receiving array is reduced to an M1-dimensional vector (or M2-dimensional vector, . . . , ML-dimensional vector, respectively) at a given time instant. This will be described in the following based on an example.

Assuming L receiving arrays enumerated from 1 to L where the i-th receiving array includes of L⁽ⁱ⁾ many receiving elements. The positions of the receiving elements of the i-th array are denoted as p⁽ⁱ⁾ⱼ where j=1, . . . , L⁽ⁱ⁾. Assuming signals received by the receiving elements to be narrow-band signals that are centered around the frequency f₀, the signal s_{q} coming from a direction pointed by the unit vector r_{q} captured by the i-th array can be written as

x_{q}⁽ⁱ⁾=a⁽ⁱ⁾(r_{q})s_{q}

where a⁽ⁱ⁾(r_{q})ε [symbol] ^{L}^{⁽ⁱ⁾} is the array steering vector of the i-th array towards direction r_{q} given by

$${a}^{( i )} ( {r}_{q} ) = ( \begin{matrix}{e}^{- j 2 π 〈 {p}_{1}^{( i )} , {r}_{q} 〉} \\ ⋮ \\ {e}^{- j 2 π 〈 {p}_{{L}_{i}}^{( i )} , {r}_{q} 〉}\end{matrix} )$$

where [symbol] p, r [symbol] denotes the inner product between the vectors p and r. Assuming there are Q many point sources in the sky, by stacking the signals emitted by these sources in a length Q vector sε [symbol] ^{Q} the signal received by the i-th receiving array can be written as

x⁽ⁱ⁾=A⁽ⁱ⁾s,

where the matrix A⁽ⁱ⁾ε [symbol] ^{L×Q} has the qth column equal to a⁽ⁱ⁾(r_{q}).

Beamforming at the i-th receiving array can be seen as transforming the L⁽ⁱ⁾ dimensional signal x⁽ⁱ⁾ by a linear operator, hence it can be represented as a matrix multiplication. The beamforming matrix at the i-th array can be denoted with W⁽ⁱ⁾ε [symbol] ^{L}^{⁽ⁱ⁾}^{×M}^{⁽ⁱ⁾} where M⁽ⁱ⁾ is the number of beamforms used at that array. The beamformer output of the i-th array can then be written as

$$\begin{matrix}{x}_{b}^{( i )} = {W}^{( i ) H} {x}^{( i )} \\ = {W}^{( i ) H} {A}^{( i )} s\end{matrix}$$

where (•)^{H} denotes a conjugate transpose of a vector. The correlator output that uses the beamformed signals from the L stations equals to

$$\hat{R} = ( \begin{matrix}{x}_{b}^{( 1 )} \\ {x}_{b}^{( 2 )} \\ ⋮ \\ {x}_{b}^{( L )}\end{matrix} ) ( {x}_{b}^{( 1 ) H} {x}_{b}^{( 2 ) H} … {x}_{b}^{( L ) H} ) = ( \begin{matrix}{W}^{( 1 ) H} {A}^{( 1 )} {\hat{Σ}}_{s} {A}^{( 1 ) H} {W}^{( 1 )} & {W}^{( 1 ) H} {A}^{( 1 )} {\hat{Σ}}_{s} {A}^{( 2 ) H} {W}^{( 2 )} & … \\ ⋮ & ⋱ & ⋮ \\ {W}^{( L ) H} {A}^{( L )} {\hat{Σ}}_{s} {A}^{( 1 ) H} {W}^{( 1 )} & … & {W}^{( L ) H} {A}^{( L )} {\hat{Σ}}_{s} {A}^{( L ) H} {W}^{( L )}\end{matrix} )$$

where \hat{Σ}ₛ is the sample autocorrelation of the signals emitted by the sources. In the field of radio astronomy, the sources are assumed to emit uncorrelated signals, so \hat{Σ}ₛ approaches a diagonal matrix as the number of samples used to calculate the correlations increases.

As can be seen from the equation above, each entry of the correlation matrix is a weighted combination of the elements of the individual correlation matrices between different receiving arrays. Whenever the matrix W⁽ⁱ⁾ε [symbol] ^{L}^{⁽ⁱ⁾}^{×M}^{⁽ⁱ⁾} matrix has less columns than rows, i.e., M⁽ⁱ⁾<L⁽ⁱ⁾, this represents a projection from a higher dimensional space to a lower dimensional space, hence information will be lost. However, by selecting the projection matrices randomly, most of the information contained within these individual correlation matrices is kept with higher probability than by uniform beamforming with the same dimensionality.

According to one aspect of the present invention, the receiving elements are antenna elements. The receiving elements can be antennas and the receiving arrays can be antenna stations. The receiving elements can also be any other kind of receiving element like sensors, transducers or the like.

According to one aspect of the present invention, the randomizing unit is adapted to generate a randomized matrix by producing random values.

One possibility to generate the randomized matrices is to produce random values and to fill the randomized matrices with the random values. The random values can be selected arbitrarily or drawn from a probability distribution. The columns of the randomized matrices should then be normalized to have unit norm.

According to one aspect of the present invention the randomizing unit is adapted to generate a randomized matrix having elements being independent and identically distributed circularly symmetric complex Gaussian random variables.

For instance, each randomized beamforming matrix W⁽ⁱ⁾, where i ranges over the index of the receiving arrays, i.e., i=1, . . . , L, can be generated to have elements with independent and identically distributed circularly symmetric complex Gaussian random variables with zero mean and unit variance.

Selecting the elements of the randomized beamforming matrices as complex Gaussian random variables leads to a straightforward computation of the statistics of the correlator output signals. This is advantageous as Gaussian random matrices are known perform well in optimization algorithms for later mage recovery.

According to one aspect of the present invention, the randomizing unit is adapted to generate a randomizing matrix by conjugate matched beamforming towards randomly chosen directions.

As an alternative to the usage of symmetric complex Gaussian random variables, the randomized beamforming matrices W⁽ⁱ⁾ can be generated by conjugate matched beamforming. This can be done towards randomly chosen directions within the region of interest. Region of interest in this case can denote a region of the sky from which signals should be received or captured.

In conjugate matched beamforming, the received signals are multiplied by the conjugates of the weights represented by the elements of the array steering vectors and then summed, yielding optimal SNR performance.

According to one aspect of the present invention, the randomizing unit is adapted to apply a filter to each of the randomized matrices to attenuate signals outside a region of interest.

After generating the beamforming matrices W⁽ⁱ⁾ each column of the beamforming matrices can be convolved with a beam-shaping filter to attenuate signals coming from outside the region of interest. The beam-shaping filter can be fixed.

According to one aspect of the present invention, the device further includes a correlation unit being adapted to generate at least one correlation signal by correlating the beamformed time-series output data signals of the plurality of receiving arrays.

The correlation unit is thus adapted to generate at least one correlation signal from a plurality of beamformed time-series output data signals. The at least one correlation signal can then be used for further processing.

According to one aspect of the present invention, the device further includes a recovering unit being adapted to recover information contained in the received signals from the at least one correlation signal.

As a plurality of beamforms are used for each array, the diversity in the measurements is increased which results in an improvement in the reconstruction fidelity. Further, the rate of data transfer between the arrays and a central data processor including for instance the recovering unit can be reduced with respect to state of the art beamforming methods that achieve the same imaging resolution and flux density recovery performance.

According to one aspect of the present invention, the recovering unit is adapted to consider the positions of the receiving elements when recovering the information contained in the received signals.

The recovering unit can use the positions of the receiving elements as well as the used randomized matrices for recovering the information contained in the received signals. The recovering unit can use any suitable algorithm for recovering the information contained in the received signal. Such an algorithm can be based for instance on Fourier imaging.

According to one aspect of the present invention, the recovering unit is adapted to perform an optimization algorithm when recovering the information contained in the received signals.

For instance, random beamforming as provided by the device can be leveraged in sparse signal reconstruction methods. In order to utilize sparse signal recovery algorithms, a grid is imposed for the source positions in the sky {rₖ}_{kεK} where K is the index set for the grid positions. The granularity of the grid determines the resolution of the image. Then, the matrix A is defined as a matrix composed of the array response vectors towards all the possible directions in the index set i, i.e., the kth column of A is equal to the vector obtained by stacking the receiving array response vectors a⁽ⁱ⁾(rₖ) for all i=1, . . . , L. Using these definitions, the signal ŝεR^{+|K|} where the entries correspond to the elements of the index set K, can be recovered by

$${minimize}_{\hat{s}} ∥ \hat{s} {∥}_{1} subject to ∥ \hat{R} - {W}^{H} A diag ( \hat{s} ) {A}^{H} W {∥}_{F} \leq ε$$

$$or by$$

$${minimize}_{\hat{s}} ∥ \hat{R} - {W}^{H} A diag ( \hat{s} ) {A}^{H} W {∥}_{F}^{2} + λ ∥ \hat{s} {∥}_{1}$$

where ∥ ∥₁ and ∥ ∥_{F} denote the L₁ norm and the Frobenius norm, respectively, the matrix W is the block diagonal matrix obtained by stacking the beamforming matrices W⁽ⁱ⁾, on the diagonal, and ε and λ are non-negative constants for constraining the reconstruction measurement residual and regularization of the solution, respectively.

According to one aspect of the present invention, the information contained in the received signals is a graphical image. For example, the graphical image can represent the sky in the case of a telescope. Another application area could be for example radio interferometry or localization of transmitting devices in a network.

Localization of transmitting devices in a built up area, such as within Wi-Fi networks, can be useful. The transmitting devices can be moving devices like mobile phones (being moved by pedestrians or cars). Knowing where devices are at a given point in time can be used for instance for traffic control (including traffic light control), policing, long-term planning, etc.

Given the huge number of devices and thus the resulting larger amount of data, mapping the devices to the area becomes intractable without rate reduction methods (the network traffic from sensors would be too large). Beamforming randomly can allow to reduce the dimensionality of the problem while still obtaining locations of sources, given the relative sparsity of devices within the total area.

The receiving elements in this case can be sensors placed at various locations to pick up activity, and the receiving arrays can be groups of sensors for which beamforms are obtained. These arrays can send the beams, i.e. the beamformed time-series output data signals, using a communications network to a central collector which then can recover a map of the underlying area.

The graphical image can also be any other kind of image like data from medical imaging. Medical imaging includes ultrasound, Magnetic Resonance Imaging (MRI), and Computed Tomography (CT). All techniques involve probing, i.e. capturing of signals represented by sound waves, magnetic field, electromagnetic radiation etc., and then detection by sensors.

In MRI, sensors are used as receiving elements to estimate samples of the spectrum of the image to be obtained. In general, beamforming can help in increasing the accuracy in these samples and in reducing the amount of data that has to be used in imaging. Random beamforming can enable large information retention in obtaining these samples, and the imaging algorithm can use a sparse reconstruction technique to obtain the content information.

Ultrasound consists of far-field and near-field effects. With the suggested device, images in the far-field can for example be obtained. Randomized beamforming can reduce the number of samples but can increase the accuracy in the image reconstruction for a given amount of data, and also can reduce the complexity of subsequent imaging. The receiving elements in this case can be transducers.

According to a second aspect, a method for receiving signals by a plurality L of receiving arrays is suggested. Each of the L receiving arrays includes a respective number L1, L2, . . . , LL of receiving elements and is adapted to generate time-series output data signals based on received signals. The method includes the following steps: generating a randomized matrix for each of the receiving arrays of the plurality L of receiving arrays, each of the randomized matrices having a respective dimensionality M1, M2, . . . , ML, wherein M1<L1, M2<L2, . . . , ML<LL, applying each of the generated randomized matrices to the corresponding receiving array of the plurality L of receiving arrays to perform beamforming across each of the receiving arrays of the plurality L of receiving arrays, and outputting beamformed time-series output data signals from each of the receiving arrays of the plurality of receiving arrays.

According to a third aspect, the invention relates to a computer program including a program code for executing at least one step of the method of the second aspect for receiving signals by a plurality of receiving arrays when run on at least one computer.

In the following, exemplary aspects of the present invention are described with reference to the enclosed figures.

### BRIEF DESCRIPTION OF THE SEVERAL VIEWS OF THE DRAWINGS

FIG. 1 shows an embodiment of a device for receiving signals by a plurality of receiving arrays;

FIG. 2 shows an example of a sky image corresponding to the signals to be received of FIG. 1;

FIG. 3 shows a diagram illustrating the signal intensity of reconstructed signals using different methods;

FIG. 4 shows an embodiment of a sequence of method steps for receiving signals by a plurality of receiving arrays;

FIG. 5 shows another embodiment of a sequence of method steps for receiving signals by a plurality of receiving arrays; and

FIG. 6 shows a schematic block diagram of an embodiment of a system adapted for performing the method for receiving signals by a plurality of receiving arrays.

Similar or functionally similar elements in the figures have been allocated the same reference signs if not otherwise indicated.

### DETAILED DESCRIPTION

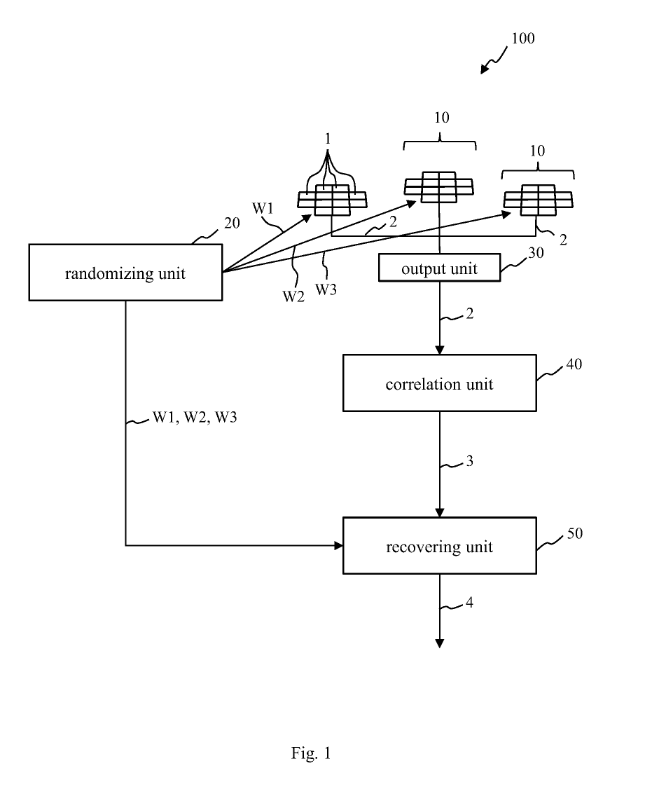

FIG. 1 shows device 100 for receiving signals by a plurality of receiving arrays 10. Receiving arrays 10 include a respective number L1, L2, L3 of receiving elements 1. Receiving arrays 10 are adapted to generate time-series output data signals 2 based on received signals. The received signals can be signals being captured by receiving arrays 10 as video and/or audio signals and can include graphical images, audio content or the like.

Device 100 includes a randomizing unit 20 being adapted to generate a randomized matrix W1, W2, W3 for each of receiving arrays 10. Randomized matrices W1, W2, W3 have a respective dimensionality M1, M2, M3, wherein M1<L1, M2<L2, M3<L3. Randomizing unit 20 can periodically generate new randomized matrices W1, W2, W3. Randomized matrices W1, W2, W3 differ from each other so that a different randomized matrix W1, W2, W3 is applied to each of the receiving arrays 10.

The generated randomized matrices W1, W2, W3 are applied to the corresponding receiving array 10 to perform beamforming across each of the receiving arrays 10. Thus, an output signal vector of each array having a dimensionality L1 is reduced to a dimensionality of M1.

Device 100 further includes an output unit 30 for outputting beamformed time-series output data signals 2 from each of receiving arrays 10. Correlation unit 40 then generates correlation signal 3 by correlating the plurality of beamformed time-series output data signals 2. Correlation signal 3 is forwarded to recovering unit 50.

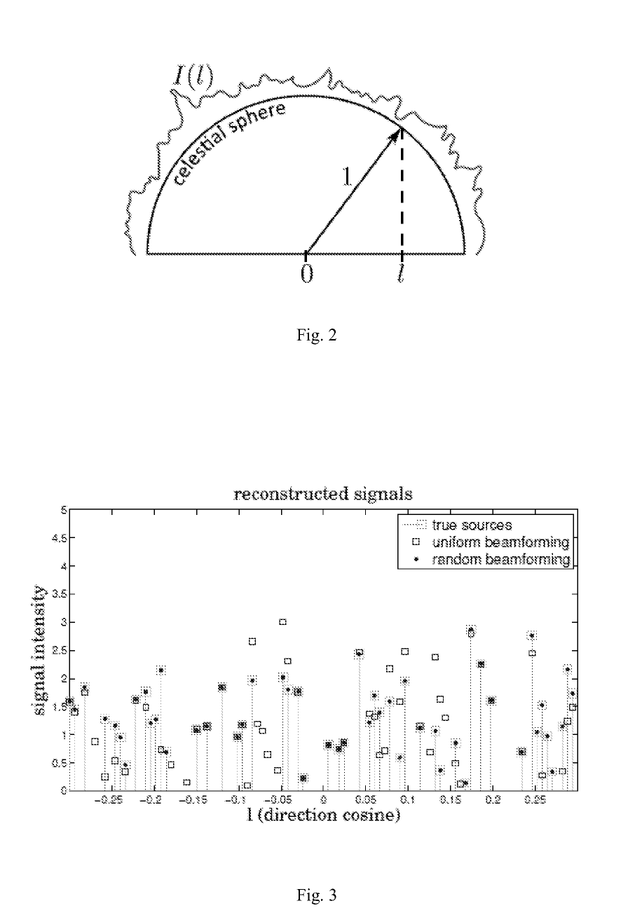

Recovering unit 50 recovers content information 4 contained in the received signal based on correlation signal 3 and randomized matrices W1, W2, W3. Content information 4 can be for instance a graphical image like a sky image. This is shown in FIG. 2. As shown, the image to be captured by receiving elements 1 is in the form of a celestial sphere. The signals being received by the receiving elements 1 have magnitude responses represented by a function I(I) of the direction cosine I. The function I(I) provides the intensity of the sources that are present in the field of view within the celestial sphere.

FIG. 3 illustrates a comparison between the signal intensities of reconstructed or recovered signals using uniform beamforming (illustrated by simple squares), i.e. commonly used methods, using randomized beamforming (illustrated by points) as provided by device 100 and the signal intensities of the true sources (illustrated by squares at the end of a line). As can be seen, using randomized beamforming provides a high signal recovery quality being very near to the true sources. Thus, almost perfect recovery can be attained by using random beamforms. In summary, using uniform beamforming, an accuracy of about 40% can be achieved wherein using randomized beamforming, an accuracy of about 100% can be achieved.

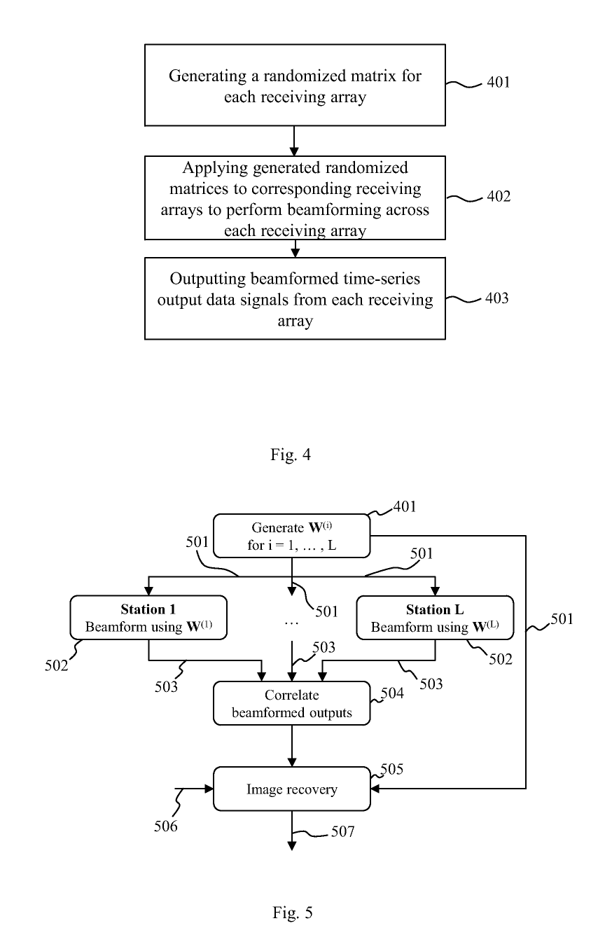

FIG. 4 shows an embodiment of a sequence of method steps receiving signals by a plurality of receiving arrays 10. The method of FIG. 4 has the following steps 401-403. In a first step 401, randomized matrix W1, W2, W3 is generated for each of the receiving arrays 10. More generally, a matrix W⁽ⁱ⁾ is generated for the receiving arrays 10 with i=1, . . . , L. In a second step 402, each of the generated randomized matrices W1, W2, W3 is applied to the corresponding receiving array 10 to perform beamforming across each of receiving arrays 10. In a third step 403, beamformed time-series output data signals 2 are output from each of receiving arrays 10.

FIG. 5 shows a further embodiment of a sequence of method steps receiving signals by a plurality of receiving arrays 10. The first step 401 is equal to the first step 401 of FIG. 4. In step 501, the randomized matrices W⁽ⁱ⁾ are forwarded to the respective receiving arrays 10, here denoted as station 1 to station L. In step 502, beamforming is carried out using the respective randomized matrices W⁽¹⁾ to W^{(L)}. In step 503, beamformed time-series output data signals 2 are forwarded to correlation unit 40. In step 504, beamformed time-series output data signals 2 are correlated to generate a correlation signal 3. In step 505, image recovery is carried out based on correlation signal 3 and antenna positions 506, i.e. the positions of the receiving elements 1. Finally, recovered content information 4, for instance a sky image, is output in step 507.

Computerized devices can be suitably designed for implementing embodiments of the present invention as described herein. In that respect, it can be appreciated that the methods described herein are largely non-interactive and automated. In exemplary embodiments, the methods described herein can be implemented either in an interactive, partly-interactive or non-interactive system. The methods described herein can be implemented in software (e.g., firmware), hardware, or a combination thereof. In exemplary embodiments, the methods described herein are implemented in software, as an executable program, the latter executed by suitable digital processing devices. In further exemplary embodiments, at least one step or all steps of above methods of FIGS. 4 and 5 can be implemented in software, as an executable program, the latter executed by suitable digital processing devices. More generally, embodiments of the present invention can be implemented wherein general-purpose digital computers, such as personal computers, workstations, etc., are used.

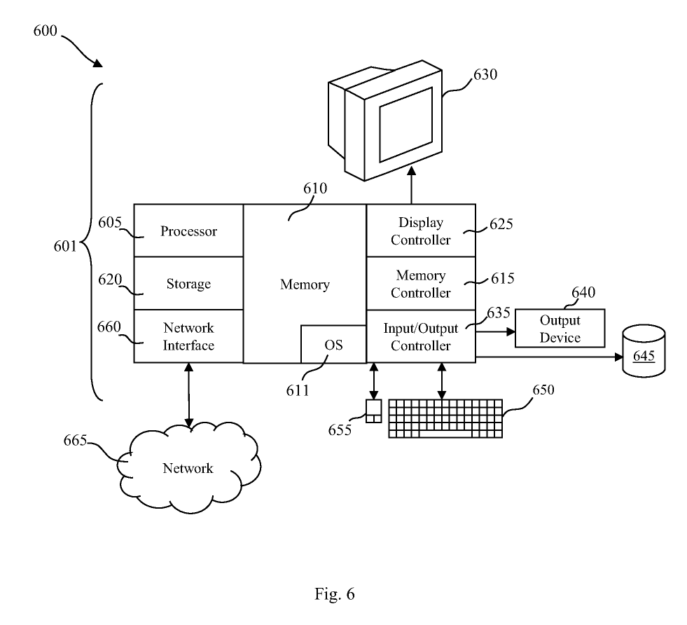

For instance, system 600 depicted in FIG. 6 schematically represents computerized unit 601, e.g., a general-purpose computer. In exemplary embodiments, in terms of hardware architecture, as shown in FIG. 6, unit 601 includes processor 605, memory 610 coupled to memory controller 615, and at least one input and/or output (I/O) devices 640, 645, 650, 655 (or peripherals) that are communicatively coupled via a local input/output controller 635. Further, input/output controller 635 can be, but is not limited to, at least one buses or other wired or wireless connections, as is known in the art. Input/Output controller 635 can have additional elements, which are omitted for simplicity, such as controllers, buffers (caches), drivers, repeaters, and receivers, to enable communications. Further, the local interface can include address, control, and/or data connections to enable appropriate communications among the aforementioned components.

Processor 605 is a hardware device for executing software, particularly that stored in memory 610. Processor 605 can be any custom made or commercially available processor, a central processing unit (CPU), an auxiliary processor among several processors associated with computer 601, a semiconductor based microprocessor (in the form of a microchip or chip set), or generally any device for executing software instructions.

Memory 610 can include any one or combination of volatile memory elements (e.g., random access memory) and nonvolatile memory elements. Moreover, memory 610 can incorporate electronic, magnetic, optical, and/or other types of storage media. Note that memory 610 can have a distributed architecture, where various components are situated remote from one another, but can be accessed by processor 605.

The software in memory 610 can include at least one separate program, each of which includes an ordered listing of executable instructions for implementing logical functions. In the example of FIG. 6, the software in memory 610 includes a method described herein in accordance with exemplary embodiments and a suitable operating system (OS) 611. OS 611 essentially controls the execution of other computer programs, such as the methods as described herein (e.g., FIGS. 4 and 5), and provides scheduling, input-output control, file and data management, memory management, and communication control and related services.

The methods described herein can be in the form of a source program, executable program (object code), script, or any other entity including a set of instructions to be performed. When in a source program form, then the program needs to be translated via a compiler, assembler, interpreter, or the like, as known per se, which can or can not be included within memory 610, so as to operate properly in connection with OS 611. Furthermore, the methods can be written as an object oriented programming language, which has classes of data and methods, or a procedure programming language, which has routines, subroutines, and/or functions.

Conventional keyboard 650 and mouse 655 can be coupled to the input/output controller 635. Other I/O devices 640-655 can include sensors (especially in the case of network elements), i.e., hardware devices that produce a measurable response to a change in a physical condition like temperature or pressure (physical data to be monitored). Typically, the analog signal produced by the sensors is digitized by an analog-to-digital converter and sent to controllers 635 for further processing. Sensor nodes are ideally small, consume low energy, are autonomous and operate unattended.

In addition, I/O devices 640-655 can further include devices that communicate both inputs and outputs. System 600 can further include display controller 625 coupled to display 630. In exemplary embodiments, system 600 can further include a network interface or transceiver 660 for coupling to network 665.

Network 665 transmits and receives data between unit 601 and external systems. Network 665 can be implemented in a wireless fashion, e.g., using wireless protocols and technologies, such as WiFi, WiMax, etc. Network 665 can be a fixed wireless network, a wireless local area network (LAN), a wireless wide area network (WAN) a personal area network (PAN), a virtual private network (VPN), intranet or other suitable network system and includes equipment for receiving and transmitting signals.

Network 665 can also be an IP-based network for communication between unit 601 and any external server, client and the like via a broadband connection. In exemplary embodiments, network 665 can be a managed IP network administered by a service provider. Besides, network 665 can be a packet-switched network such as a LAN, WAN, Internet network, etc.

If unit 601 is a PC, workstation, intelligent device or the like, the software in memory 610 can further include a basic input output system (BIOS). The BIOS is stored in ROM so that the BIOS can be executed when computer 601 is activated.

When unit 601 is in operation, processor 605 is configured to execute software stored within memory 610, to communicate data to and from memory 610, and to generally control operations of computer 601 pursuant to the software. The method described herein and OS 611, in whole or in part are read by processor 605, typically buffered within processor 605, and then executed. When the methods described herein (e.g. with reference to FIGS. 4 and 5) are implemented in software, the methods can be stored on any computer readable medium, such as storage 620, for use by or in connection with any computer related system or method.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects. Furthermore, aspects of the present invention can take the form of a computer program product embodied in at least one computer readable medium(s) having computer readable program code embodied thereon. Any combination of at least one computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device. Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of at least one programming languages, including an object oriented programming language such as Java, Smalltalk, C++ or the like and conventional procedural programming languages, such as the “C” programming language or similar programming languages. The program code can execute entirely on unit 601, partly thereon, partly on a unit 601 and another unit 601, similar or not.

Aspects of the present invention are described above with reference to flowchart illustrations and/or block diagrams of methods, apparatus (systems) and computer program products according to embodiments of the invention. It will be understood that each block of the flowchart illustrations and/or block diagrams can be implemented by at least one computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams can represent a module, segment, or portion of code, which includes at least one executable instructions for implementing the specified logical function(s). It should also be noted that, in some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved and algorithm optimization. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been described with reference to certain embodiments, it will be understood by those skilled in the art that various changes can be made and equivalents can be substituted without departing from the scope of the present invention. In addition, modifications can be made to adapt a particular situation to the teachings of the present invention without departing from its scope. Therefore, it is intended that the present invention not be limited to the particular embodiments disclosed, but that the present invention will include all embodiments falling within the scope of the appended claims.

We claim:

1. A device for receiving signals by a plurality of receiving arrays, the device comprising:
a plurality L of receiving arrays, each of the receiving arrays including a respective number L1, L2, . . . , LL of receiving elements and being adapted to generate time-series output data signals based on received signals;
a randomizing unit being adapted to generate a randomized matrix for each of the receiving arrays of the plurality L of receiving arrays, each of the randomized matrices having a respective dimensionality M1, M2, . . . , ML, wherein M1<L1, M2<L2, . . . , ML<LL, wherein each of the generated randomized matrices is applied to the corresponding receiving array of the plurality L of receiving arrays to perform beamforming across each of the receiving arrays of the plurality L of receiving arrays; and
an output unit being adapted to output beamformed time-series output data signals from each of the receiving arrays of the plurality L of receiving arrays.

2. The device of claim 1, wherein each of the received signals has a dimensionality L1, L2, . . . , LL and wherein each of the beamformed time-series output data signals has a dimensionality M1, M2, . . . , ML.

3. The device of claim 1, wherein the randomizing unit is adapted to, when performing beamforming across each of the receiving arrays, combine the time-series-output data signals based on received signals from each of the receiving elements of the corresponding receiving array according to the corresponding randomized matrix.

4. The device of claim 1, wherein the receiving elements are antenna elements.

5. The device of claim 1, wherein the randomizing unit is adapted to generate a randomized matrix by producing random values.

6. The device of claim 1, wherein the randomizing unit is adapted to generate a randomized matrix having elements being independent and identically distributed circularly symmetric complex Gaussian random variables.

7. The device of claim 1, wherein the randomizing unit is adapted to generate randomizing matrix by conjugate matched beamforming towards randomly chosen directions.

8. The device of claim 5, wherein the randomizing unit is adapted to apply a filter to each of the randomized matrices to attenuate signals outside a region of interest.

9. The device of claim 1, further comprising:
a correlation unit being adapted to generate at least one correlation signal by correlating the beamformed time-series output data signals of the plurality of receiving arrays.

10. The device of claim 9, further comprising:
a recovering unit being adapted to recover information contained in the received signals from the correlation signal.

11. The device of claim 10, wherein the recovering unit is adapted to consider the positions of the receiving elements when recovering the information contained in the received signals.

12. The device of claim 10, wherein the recovering unit is adapted to perform an optimization algorithm when recovering the information contained in the received signals.

13. The device of claim 10, wherein the information contained in the received signals is a graphical image.

14. A method for receiving signals by a plurality L of receiving arrays, each of the L receiving arrays including a respective number L1, L2, . . . , LL of receiving elements and being adapted to generate time-series output data signals based on received signals, the method comprising:
generating a randomized matrix for each of the receiving arrays of the plurality of L receiving arrays, each of the randomized matrices having a respective dimensionality M1, M2, . . . , ML, wherein M1<L1, M2<L2, . . . , ML<LL;
applying of the generated randomized matrices to the corresponding receiving array of the plurality L of receiving arrays to perform beamforming across each of the receiving arrays of the plurality L of receiving arrays; and
outputting beamformed time-series output data signals from each of the receiving arrays of the plurality of L receiving arrays.

15. A computer readable non-transitory article of manufacture tangibly embodying computer readable instructions which, when executed, cause a computer to carry out at least one step of a method according to claim 14 for receiving signals by a plurality of receiving arrays when run on at least one computer.
